(19) United States
(12) Patent Application Publication
(10) Pub. No.: US 2008/0005026 A1
(43) Pub. Date: Jan. 3, 2008

(54) AUTOMATIC SOFTWARE REGISTRATION

(75) Inventors: Brian D. Cross, Redmond, WA (US); Jason W. Fuller, Bellevue, WA (US); Luis Eduardo Cabrera-Cordon, Bothell, WA (US); Nikola Radicevic, Seattle, WA (US); Preethi M. Mohan, Redmond, WA (US); Robert Levy, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/428,089

(22) Filed: Jun. 30, 2006

(51) Int. Cl. H04K 1/00; H04L 9/00

(52) U.S. Cl. 705/51

(57) ABSTRACT

A client-side software registration component is leveraged to automatically obtain software registration information from a software distributor's server. The software registration information is then decoded to obtain a registration code for a software application. The registration code is then stored so that the software application can access it. Other instances include a server-side software registration component that interacts with an independent software vendor (ISV) to obtain software registration mechanisms for a software distributor. The software registration mechanisms are then utilized to encode software registration information. The software registration information is then made available to client-side registration components to facilitate in automatic software application registration.

### BACKGROUND

Independent Software Vendors (ISVs) let software distributors sell their software to end users. Currently ISVs use a variety of methods to verify that their applications are not copied illegally. Most of them use some kind of registration mechanism where the user has to “register” their application. These registration codes are generated by an algorithm arbitrarily chosen by the software developer. Usually this requires the user to have to enter a long string that they received over email or a web page. When these applications are run, they prompt the user to enter the registration code in order to “activate” the application or “unlock” specific features of it. Once entered by the user, applications store the entered registration code in an arbitrary location. The applications then check this location each time they are run in the future to determine that the user does not need to be prompted again to enter a registration code.

One problem with this model is that registration codes can be difficult to enter by end users, especially on mobile devices since the registration codes can be long, cryptic, and contain ambiguous characters such as 0 (number) and O (letter). Another problem is that the registration codes are provided to the user outside the context of where they need to be entered. For example, it is common to buy an application from a website, retrieve a registration code in email, and then enter that code into the purchased application. This requires much patience on the part of the user and is especially difficult on mobile devices where switching between multiple applications is not an easy task. These problems result in both the loss of sales from casual users and an increase in technical support costs for software developers and the stores that sell this software.

### SUMMARY

The subject matter relates generally to software application registration, and more particularly to automatic registration of distributed ISV software applications. A client-side software registration component is leveraged to automatically obtain software registration information from, for example, a software distributor's server. The software registration information is then decoded to obtain a registration code for a software application. The registration code is then stored so that the software application can access it. Other instances include a server-side software registration component that interacts with an ISV to obtain software registration mechanisms for a software distributor. The software registration mechanisms are then utilized to encode software registration information. The software registration information is then made available to client-side registration components to facilitate in automatic software application registration. In general, the automatic software registration is transparent to an end-user of the registered software application. These types of software registration substantially increase end-user satisfaction, especially for end-users that run software applications on input limited devices such as, for example, mobile devices and the like. The automatic software registration also substantially reduces technical support for improper registrations.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of an automatic software registration system in accordance with an aspect of an embodiment.

FIG. 2 is another block diagram of an automatic software registration system in accordance with an aspect of an embodiment.

FIG. 3 is yet another block diagram of an automatic software registration system in accordance with an aspect of an embodiment.

FIG. 4 is an illustration demonstrating automatic software registration and software application interaction in accordance with an aspect of an embodiment.

FIG. 5 is an example flow chart of how software registration controls access to a software application in accordance with an aspect of an embodiment.

FIG. 6 is a data flow chart of a software application registration process in accordance with an aspect of an embodiment.

FIG. 7 is a flow diagram of a method of facilitating software application registration in accordance with an aspect of an embodiment.

FIG. 8 is another flow diagram of a method of facilitating software application registration in accordance with an aspect of an embodiment.

FIG. 9 illustrates an example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

Instances herein automate the process of obtaining arbitrary registration codes from a store where a software application is purchased and storing these registration codes in arbitrary locations designated by a software application. When the application is then run, it sees that the registration code has already been entered, and the user is never asked to manually enter it, substantially increasing user satisfaction. For example, instances herein can be used to gain the ability for an application catalog distributor to provision the registration codes directly on a mobile device. This makes the installation user experience more pleasant and faster as the end user does not need to wait to receive the registration code (e.g., through email/SMS), and the end-user does not need to enter the registration code on a device with limited input. After the application is installed and registration codes are registered by the catalog application, the end-user can just start using the application.

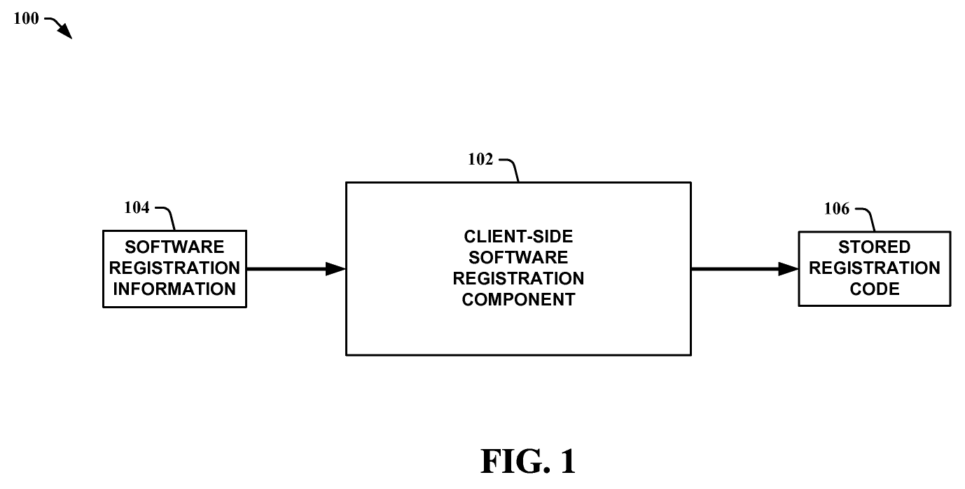

In FIG. 1, a block diagram of an automatic software registration system 100 in accordance with an aspect of an embodiment is shown. The automatic software registration system 100 is comprised of a client-side software registration component 102 that receives software registration information 104 and provides stored registration code 106. The software registration information 104 is typically comprised of an encoded software registration code and related information such as, for example, product ID, distributor ID, product version, and/or additional registration data (e.g., expiration dates, etc.). The client-side software registration component 102 resides on a client and can obtain the software registration information 104 from a local and/or remote source such as, for example, a server (e.g. a software distributor's server).

Thus, in one example, the client-side software registration component 102 can retrieve the software registration information 104 from the same server from which a client has downloaded a desired software application. This allows the software registration information 104 to pass to the client in a seemingly transparent fashion along with the desired software application. The client-side software registration component 102 then automatically processes the software registration information 104, extracts a software registration code, and provides the stored registration code 106. The stored registration code 106 is stored in a location that is determined from the software registration information 104 and is generally application-specific. The stored registration code 106 can also be comprised of multiple codes that are stored in multiple locations. The stored locations are typically known by the software application and are checked upon startup to authorize the running of the software application.

Because the client-side software registration component 102 resides on the client, the processing of the software registration information 104 is completed automatically without requiring intervention by an end-user of the software application. This allows the end-user to begin using their downloaded software application almost immediately without having to wait for registration codes to be emailed or sent to them. This is especially useful with mobile products such as, for example, mobile phones where entry of cryptic registration codes is not easily performed due to limited input capabilities. The automatic software registration system 100 also eliminates human error and/or ambiguities when entering registration codes. This drastically reduces the technical support necessary to get the software application up and running. If an end-user can immediately start using their downloaded software without waiting for codes or dealing with technical support, their satisfaction with the software product will be substantially increased.

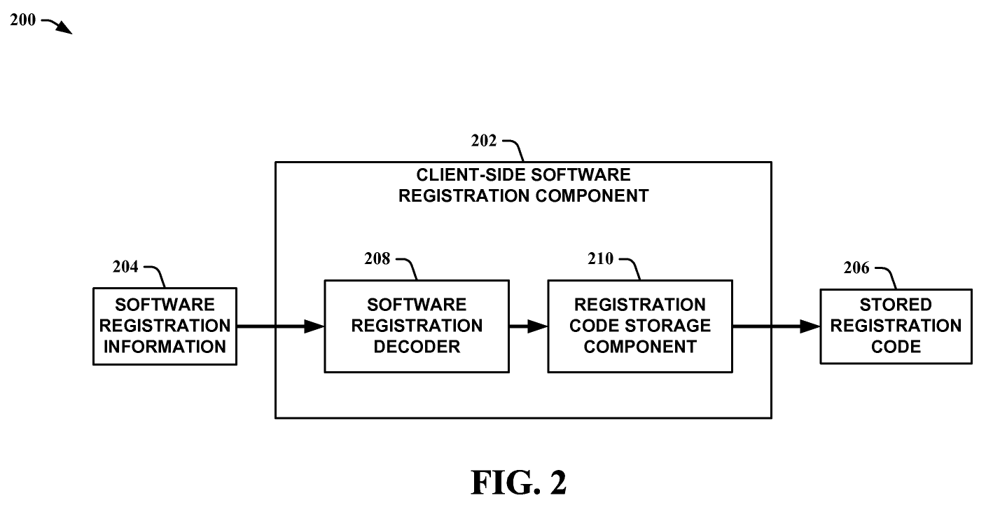

Turning to FIG. 2, another block diagram of an automatic software registration system 200 in accordance with an aspect of an embodiment is depicted. The automatic software registration system 200 is comprised of a client-side software registration component 202 that receives software registration information 204 and provides stored registration code 206. The client-side software registration component 202 is comprised of a software registration decoder 208 and a registration code storage component 210. As stated previously, the software registration information 204 is typically comprised of an encoded software registration code and related information such as, for example, product ID, distributor ID, product version, and/or additional registration data (e.g., expiration dates, etc.). The client-side software registration component 202 resides on a client and can obtain the software registration information 204 from a local and/or remote source such as, for example, a server (e.g., a software distributor's server).

The software registration decoder 208 obtains the software registration information 204 and decodes it 204 to extract the registration code or codes. The software registration decoder 208 can also extract related information such as, for example, registration code storage locations, related software products, and/or versions and the like. For example, the software registration information 204 can be embedded using extensible markup language (XML) and automatically extracted by the software registration decoder 208 residing on the client. The registration code storage component 210 then receives, at a minimum, the registration code and registration code storage location information from the software registration decoder 208. The registration code storage component 210 then stores the registration code in the extracted storage location to provide the stored registration code 206. If multiple registration codes are present, the registration code storage component 210 can store them in their respective storage locations. Properly stored registration codes allow a client-side software application to check the appropriate locations for authorization to run. The storage locations can be local and/or remote to the client-side software application. This allows remote storage of all registration codes for security and/or ease-of-access and the like. For example, the remote storage location can reside on a remote server accessible via the Internet and the like.

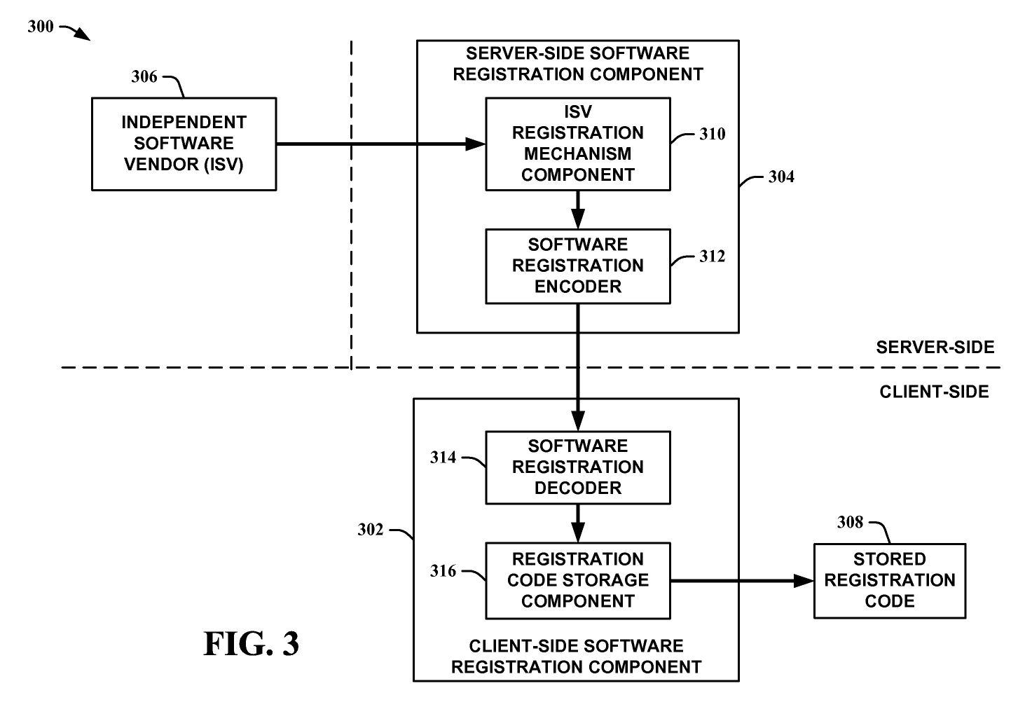

Looking at FIG. 3, yet another block diagram of an automatic software registration system 300 in accordance with an aspect of an embodiment is illustrated. The automatic software registration system 300 is comprised of a server-side software registration component 304 and a client-side software registration component 302 that interacts with independent software vendor (ISV) 306 to provide stored registration code 308. The server-side software registration component 304 is comprised of an ISV registration mechanism component 310 and a software registration encoder 312. The client-side software registration component 302 is comprised of a software registration decoder 314 and a registration code storage component 316.

The server-side software registration component 304 provides the client-side software registration component 302 with software registration information formulated for a particular independent software vendor (ISV) 306. The server-side software registration component 304 can communicate the software registration information to the client-side software registration component 302 via, for example, the Internet (i.e., global communication system), an Intranet, a wired means, and/or wirelessly (e.g., via satellite, microwave, radio wave, etc.) and the like. Similar communication means can also be utilized between the server-side software registration component 304 and the independent software vendor (ISV) 306.

The ISV registration mechanism component 310 obtains an ISV registration mechanism from the independent software vendor (ISV) 306. The ISV registration mechanism is a means for ISVs to tailor their registration processes for individual software distributors and/or software applications in a standardized fashion. This also allows identification and/or tracking of the sources of the ISV software applications (very useful when the software application is being illegally used and/or distributed). The software registration mechanism is typically comprised of a registration code algorithm with various input parameters to specialize the registration code. The parameters can include, for example, a distributor ID, date of purchase, software application, version of the software application, etc. The independent software vendor (ISV) 306 can send the ISV registration mechanism to their distributors and/or the distributors can, for example, poll an ISV's server for the correct ISV registration mechanism.

Once the ISV registration mechanism component 310 has obtained the ISV registration mechanism it is made available to the software registration encoder 312. The software registration encoder 312 employs the ISV registration mechanism to encode at least one registration code to send to the client-side software registration component 302. The software registration encoder 312 can utilize, for example, XML to send the software registration information to the software registration decoder 314 of the client-side software registration component 302. The server-side software registration component 304 thus provides a unique registration process that is tailored for a particular software distributor and ISV.

As noted supra, the software registration decoder 314 automatically decodes the software registration information and provides the registration codes and/or registration storage locations to the registration code storage component 316. The registration code storage component 316 then automatically stores the registration code or codes in appropriate locations to provide the stored registration code 308. The entire server-side and client-side process can be fully automated so that the ISVs need only prepare appropriate registration mechanisms for distributors and make them available. This allows ISVs to concentrate on developing software applications instead of distributing their software. The ISV is also no longer responsible for maintaining and/or allocating registration codes with the instances disclosed herein, saving the ISVs substantial time and effort.

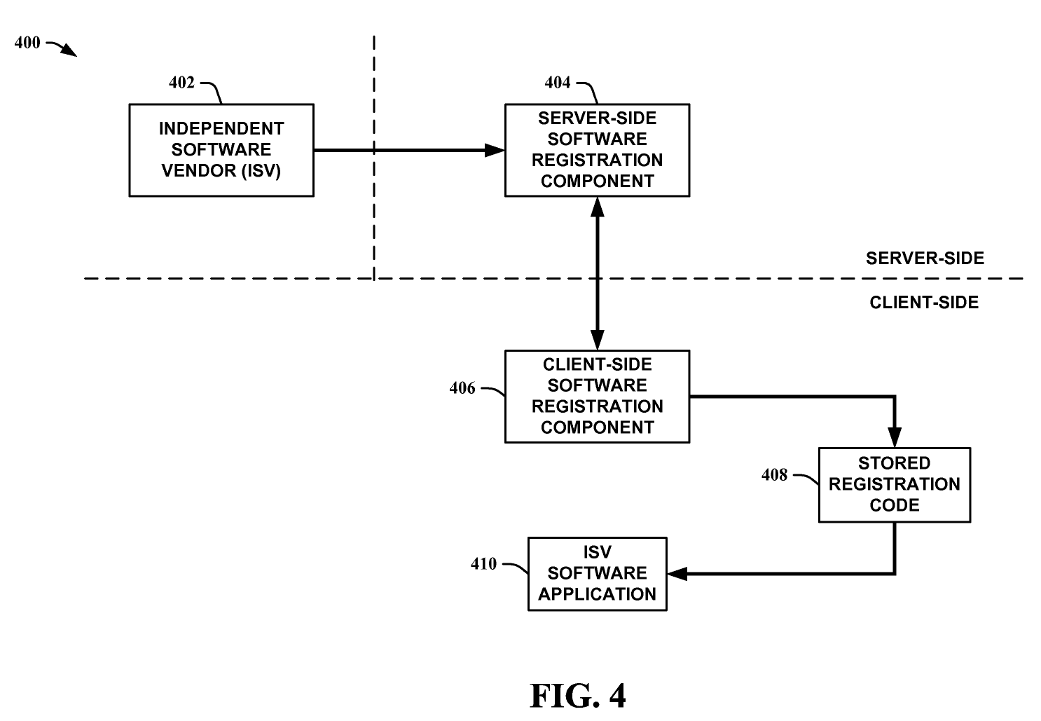

Referring to FIG. 4, an illustration 400 demonstrating automatic software registration and software application interaction in accordance with an aspect of an embodiment is shown. The illustration 400 shows an independent software vendor (ISV) 402 sending a software registration mechanism to a server-side software registration component 404. The server-side registration component 404 employs the software registration mechanism to provide a client-side software registration component 406 with requested software registration information. The client-side software registration component 406 automatically decodes the software registration information and provides a stored registration code 408.

In this example, an ISV software application 410 that is stored on the client reads the stored registration code 408 upon startup to determine if it is authorized to run. Thus, in this example, the client-side software registration component 406 and the ISV software application 410 are not required to interact directly. In other instances, however, additional information and/or validation and the like can occur between the client-side software registration component 406 and the ISV software application 410. Likewise, if desirable, the ISV software application 410 can still interact with the independent software vendor (ISV) 402. The instances disclosed herein provide automated solutions to third party software registration with the flexibility to allow integration with and/or replacement of existing registration processes, allowing other manual modes to be utilized as a back-up process, etc.

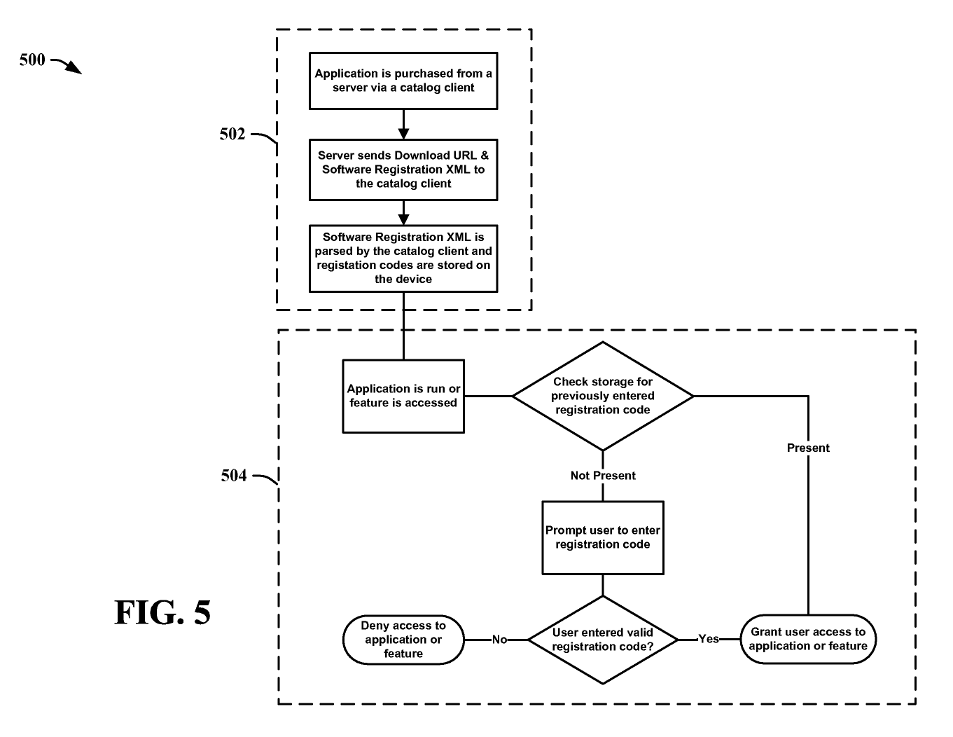

In FIG. 5, an example flow chart 500 of how software registration controls access to a software application in accordance with an aspect of an embodiment is depicted. The flow chart 500 illustrates an instance 502 disclosed herein combined with a traditional process 504 of software application authorization. The instance 502 includes purchasing a software application via a server from a client. The server sends a download uniform resource locator (URL) and an XML software registration to the client. The client then parses the software registration XML and stores the registration codes on the client side. This allows for seamless integration with the traditional process 504 of software authorization. This includes starting the application and checking storage for the registration codes. If the codes are found, the software application is authorized to run. If no codes are present, an option can be given to manual input a registration code. If no codes are stored and the manual entry is invalid, access to the software application is denied.

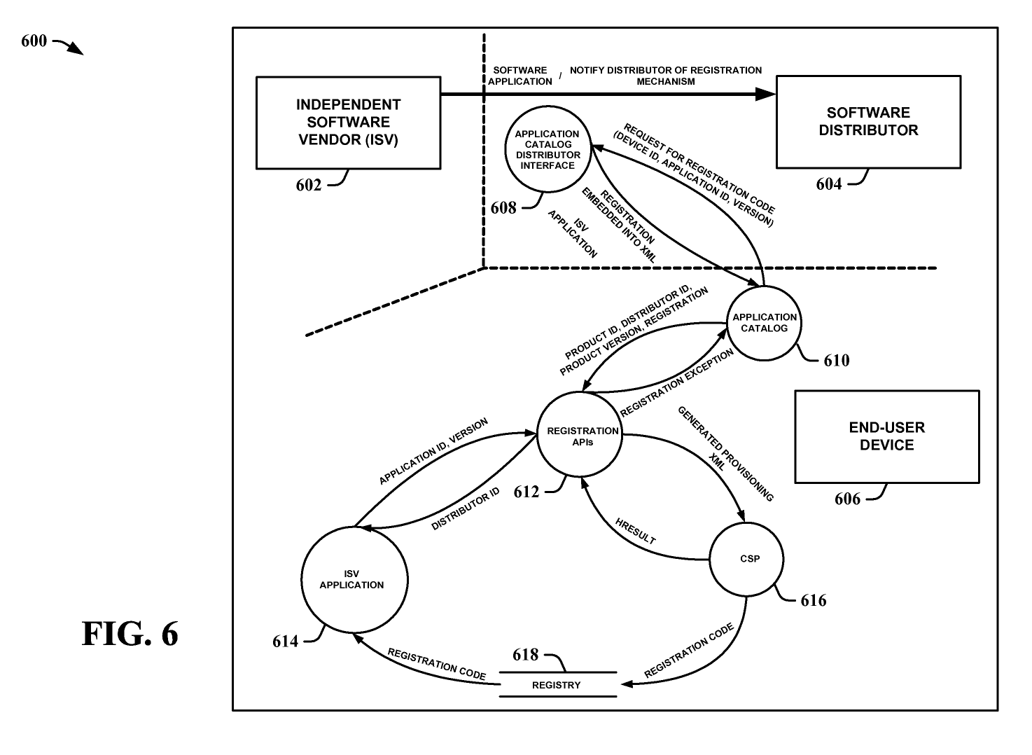

Looking at FIG. 6, a data flow chart of a software application registration process 600 in accordance with an aspect of an embodiment is illustrated. This example of an instance of the software application registration process 600 includes utilization of an application catalog. A software distributor 604 employs an application catalog process that includes an application catalog distributor interface 608. An independent software vendor (ISV) 602 sends the software distributor 604 a software application and a registration mechanism. An end-user device 600 contains an application catalog 610 from which a software application is selected and requested from the application catalog distributor interface 608. A request is also made for registration of the requested software application. Registration information received from the application catalog distributor interface 608 is then passed to registration APIs 612. Registration information encoded in XML is provided to a configuration service provider (CSP 616) which stores the registration codes in a registry 618. When an ISV application 614 runs, it checks the registry 618 for the registration code for authorization. In this example, additional information related to the software distributor 604 is also provided to the ISV application 614.

Thus, when software is purchased through an application designed to enable the discovery, purchase, and download of software (a “catalog client”), the process of retrieving and entering registration codes can be 100% automated. APIs can be utilized to establish a process where the registration occurs transparently by establishing a communication protocol between ISVs and distributors. The registration mechanisms provided herein can consist of a set of private methods that can be used to register applications from a given distributor and a schema that distributors can use to provide registration information. In one instance, the client application then receives a set of registration codes in a specialized registration markup language. This specifies registration codes, their data type, and where they can be stored. Upon receipt, this XML node is parsed, and the specified registration codes are written to the specified locations. When the purchased software is executed, it sees these registration codes and end users are never prompted to enter them manually.

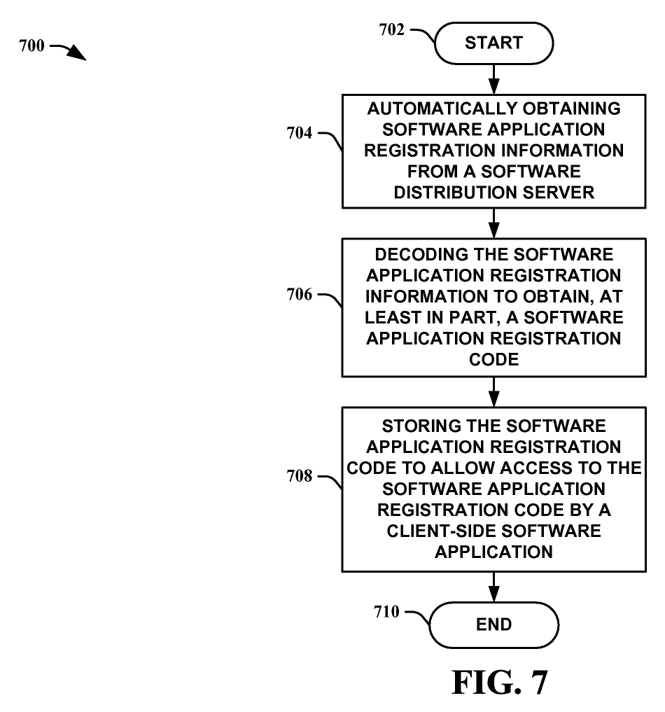

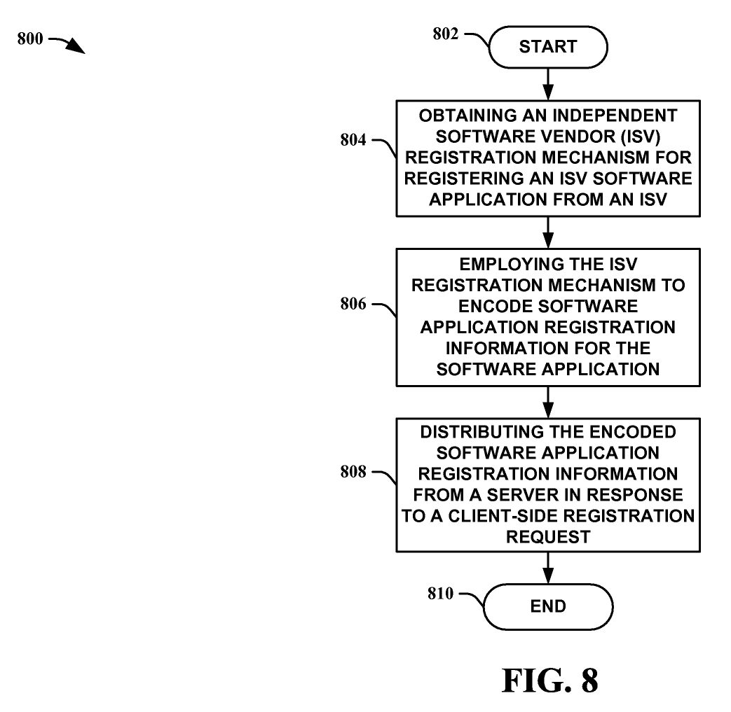

In view of the exemplary systems shown and described above, methodologies that may be implemented in accordance with the embodiments will be better appreciated with reference to the flow charts of FIGS. 7-8. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

Turning to FIG. 7, a flow diagram of a method 700 of facilitating software application registration in accordance with an aspect of an embodiment is shown. The method 700 starts 702 by automatically obtaining software application registration information from a software distribution server 704. The information can be obtained from the server via an Internet, intranet, and/or wireless connection and the like. Software distribution servers typically contain various third party software developed by independent software vendors (ISVs). The software application registration information is often encoded based upon registration algorithms provided by the ISVs. The software application registration information is then decoded to obtain, at least in part, a software application registration code 706. Often location information is also obtained that indicates where a registration code is to be stored for access by a software application. The software application registration code is then stored to allow access to the software application registration code by a client-side software application 708, ending the flow 710. When the software application registration code is appropriately stored, the software application can access the registration code or codes to allow it to run.

Referring to FIG. 8, another flow diagram of a method 800 of facilitating software application registration in accordance with an aspect of an embodiment is depicted. The method 800 starts 802 by obtaining an independent software vendor (ISV) registration mechanism for registering an ISV software application from an ISV 804. The registration mechanism is typically comprised of a registration algorithm that is specifically designed for a particular software distributor. This allows the ISV to track distribution and/or use of their software based upon the registration codes. The ISV registration mechanism is then employed to encode software application registration information for the software application 806. In general, parametric data related to purchased software is utilized as inputs to the registration mechanism's algorithm so that the registration code reflects those inputs. Such inputs can include, but are not limited to, distributor ID, purchaser, software application, and/or software application version and the like. The encoded software application registration information is then distributed from a server in response to a client-side registration request 808, ending the flow 810. The client-side registration request generally coincides with purchasing and downloading a software application. The request is typically automated so that the purchase of the software application triggers the request. In this way, the registration process on the client-side can be automated transparently to an end-user of the software application.

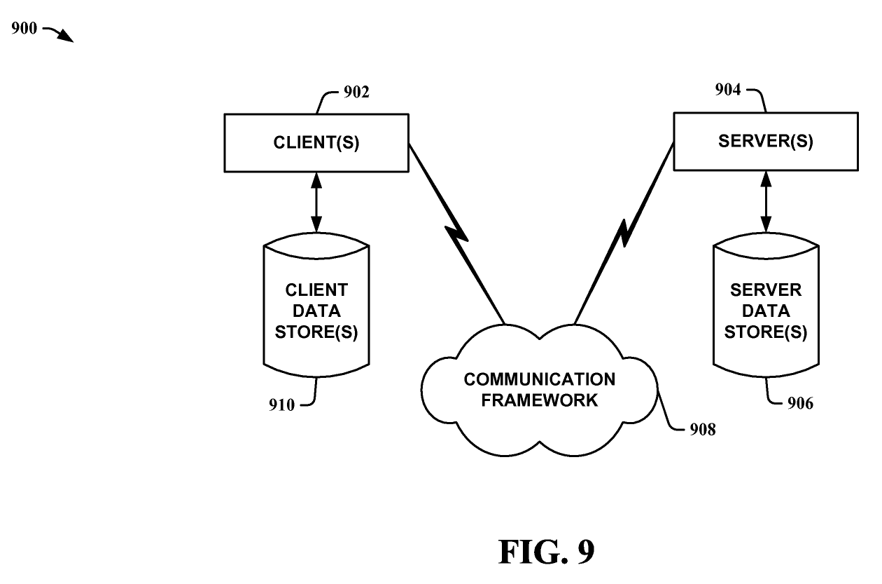

FIG. 9 is a block diagram of a sample computing environment 900 with which embodiments can interact. The system 900 further illustrates a system that includes one or more client(s) 902. The client(s) 902 can be hardware and/or software (e.g., threads, processes, computing devices). The system 900 also includes one or more server(s) 904. The server(s) 904 can also be hardware and/or software (e.g., threads, processes, computing devices). One possible communication between a client 902 and a server 904 can be in the form of a data packet adapted to be transmitted between two or more computer processes. The system 900 includes a communication framework 908 that can be employed to facilitate communications between the client(s) 902 and the server(s) 904. The client(s) 902 are connected to one or more client data store(s) 910 that can be employed to store information local to the client(s) 902. Similarly, the server(s) 904 are connected to one or more server data store(s) 906 that can be employed to store information local to the server(s) 904.

It is to be appreciated that the systems and/or methods of the embodiments can be utilized in software registration facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates software registration, comprising:
a client-side software registration component that automatically registers a client-side software application, the automatic registration incorporates software application parameters to facilitate application registration.

2. The system of claim 1, the software application parameters include, but are not limited to, a registration code, a registration code storage location, and/or a data type.

3. The system of claim 2, at least one of the software application parameters is software distributor-specific.

4. The system of claim 1, the client-side software registration component comprising:
a software registration decoder that receives software registration information from a software distributor and automatically decodes the software registration information to obtain, at least in part, a software registration code; and
a registration code storage component that automatically stores the software registration code in a location determined from the software registration information.

5. The system of claim 1 further comprising:
a server-side software registration component that interacts with an independent software vendor (ISV) and the client-side software registration component to facilitate automatic software registration.

6. The system of claim 5, the server-side software registration component comprising:
an ISV registration mechanism component that obtains a registration mechanism from the ISV for registering an ISV software application; and
a software registration encoder that encodes registration information for the ISV software application and provides it to the client-side software registration component.

7. The system of claim 1, the client-side software registration component comprising:
an application catalog client that interacts with a software application distribution server to obtain software application registration information; and
a software application registration application programming interface (API) that interacts with the client-side application and the application catalog client to facilitate software application identification and software application registration.

8. The system of claim 1, the client-side software registration component establishes a communication protocol between an independent software vendor (ISV) application and a software application distributor to facilitate automatic application registration.

9. The system of claim 1, the software registration is transparent to an end-user of the software application.

10. A mobile device that employs the system of claim 1.

11. A method of registering a software application, comprising:
automatically obtaining software application registration information from a software distribution server;
decoding the software application registration information to obtain, at least in part, a software application registration code; and
storing the software application registration code to allow access to the software application registration code by a client-side software application.

12. The method of claim 11 further comprising:
storing the software application registration code in a remote location relative to the client-side software application.

13. The method of claim 11 further comprising:
obtaining an independent software vendor (ISV) registration mechanism for registering an ISV software application from an ISV;
employing the ISV registration mechanism to encode software application registration information for the software application; and
distributing the encoded software application registration information from a server in response to a client-side registration request.

14. The method of claim 13 further comprising:
incorporating distributor-specific information into the software application registration information to facilitate identifying a distribution source of a software application.

15. The method of claim 13 further comprising:
employing a software application and/or distributor-specific ISV registration mechanism to facilitate identification of the software application and/or software application distributor.

16. The method of claim 11 further comprising:
obtaining software product identification and/or software product version from the software application registration information.

17. The method of claim 11 further comprising:
employing an application catalog client to interact with a software application distribution server to obtain the software application registration information; and
utilizing a software application registration application programming interface (API) to interact with the client-side software application and the application catalog client to facilitate software application identification and software application registration.

18. A mobile device that employs the method of claim 11.

19. A system that facilitates client-side software registration comprising:
means for automatically decoding software registration information received from a software distributor and obtaining, at least in part, a software registration code; and
means for automatically storing the software registration code in a location obtained from the software registration information.

20. A device employing the method of claim 11 comprising at least one selected from the group consisting of a computer, a server, and a handheld electronic device.
